(19) United States
(12) Patent Application Publication
(10) Pub. No.: US 2011/0065370 A1
(43) Pub. Date: Mar. 17, 2011

(54) AIR COLLECTOR INTEGRATION WITH WORKSTATION

(76) Inventors: John Reid, Royal Oak, MI (US); James K. Reid, Gahanna, OH (US)

(21) Appl. No.: 12/880,933

(22) Filed: Sep. 13, 2010

Related U.S. Application Data
(60) Provisional application No. 61/241,422, filed on Sep. 11, 2009.

(51) Int. Cl. B08B 15/00; B23P 19/04

(52) U.S. Cl. 454/63; 29/428

(57) ABSTRACT

An air collector workstation assembly is provided comprising a plurality of workstation walls defining a work area. Each of the plurality of workstation walls comprises a plurality of wall panels mounted to a plurality of frame members. Each of the plurality of wall panels has a panel width and a panel height. At least one wall panel comprises an adjustable dimension wall panel having at least one removable panel portion to adjust the panel height. An air collector unit with a mounting profile having an air intake width and an air intake height is mounted to one of the workstation walls. The air intake width is approximately equal to the panel width. The removable panel portion can be removed and the mounting profile inserted to place the air collector in communication with the work area.

### CROSS-REFERENCE TO RELATED APPLICATIONS

The present invention is a non-provisional of U.S. Application No. 61/241,422 filed Sep. 11, 2009.

### TECHNICAL FIELD

The present invention relates generally to an air collector and more particular to a air collector assembly integrated into a work station to incorporate a variety of mounting positions.

### BACKGROUND OF THE INVENTION

Work stations incorporating air cleaning systems are known and utilized in a variety of industries. In many manufacturing industries, processes such as welding generate undesirable byproducts such as dust or hazardous substances. Separate work stations or work areas are often utilized to contain these substances produced during manufacturing operations.

The size and configuration of work stations for air purification can vary from small hood style arrangements to full room enclosures. In some instances the work stations or room enclosures are required to be portable. This feature allows them to be erected surrounding equipment at a given site and in addition to be moved to accommodate assembly line reconfigurations. Known structures, however, allow for relatively limited reconfigurations from their original designs. This can restrict their usage, such as when their configuration is not compatible with assembly line space limitations.

In addition, work stations with restrained design modifications may not be compatible with other production layouts. It would therefore be highly desirable to have an air collector assembly that could quickly and efficiently be mounted into a variety of positions on a workstation.

### SUMMARY OF THE INVENTION

In accordance with the objects of the present invention, an air collector workstation assembly is provided. The air collector workstation assembly comprises a plurality of workstation walls defining a work area. Each of the plurality of workstation walls comprises a plurality of wall panels mounted to a plurality of frame members. Each of the plurality of wall panels has a panel width and a panel height. At least one wall panel comprises an adjustable dimension wall panel having at least one removable panel portion to adjust the panel height. An air collector unit with a mounting profile having an air intake width and an air intake height is mounted to one of the workstation walls. The air intake width is approximately equal to the panel width. The removable panel portion can be removed and the mounting profile inserted to place the air collector in communication with the work area.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of an embodiment of an air collector workstation assembly in accordance with the present invention.

FIG. 2 is an illustration of an alternate embodiment of an air collector workstation assembly in accordance with the present invention.

FIG. 3 is a detailed illustration of an air collector for use in the air collector workstation assembly illustrated in FIG. 1.

FIG. 4 is a detailed illustration of an alternate air collector for use in the air collector workstation assembly illustrated in Figure I.

FIG. 5 is an exploded view detail illustration of the air collector mount to a wall panel for use in the air collector workstation assembly shown in FIGS. 1 and 2.

FIG. 6 is the air collector workstation mounting illustrated in FIG. 5.

FIG. 7 is the air collector workstation mounting illustrated in FIG. 5, the mounting including the use of a boot element is a wall panel illustration for use in the mounting illustrated in FIG. 5.

FIG. 8 is a detailed illustration of an embodiment of the wall panel for use as shown in FIG. 5, the illustration detailing a template.

FIG. 9 is a detailed illustration of an embodiment of the wall panel for use as shown in FIG. 5, the illustration detailing a perforation line.

FIG. 10 is a detailed illustration of a second embodiment of the wall panel for use as shown in FIG. 5, the illustration detailing a weakened break line.

FIG. 11 is a cross sectional illustration of the weakened break line shown in FIG. 10,

FIG. 12 is a detailed illustration of a further embodiment of the wall panel for use as shown in FIG. 5, the illustration detailing a removable panel 56.

FIG. 13 is a detailed illustration of an embodiment of the wall panel shown in FIG. 5, the detail illustrating a rubberized external surface.

FIG. 14 is a cross sectional illustration of the wall panel illustrated in FIG. 13.

### DESCRIPTION OF PREFERRED EMBODIMENTS

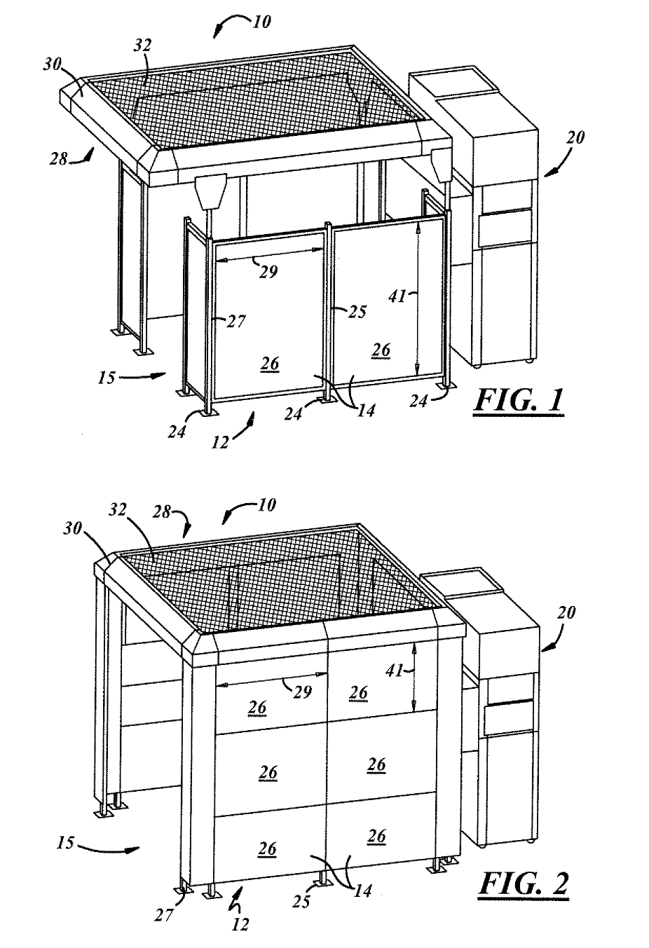

Referring now to FIGS. 1 and 2, which is an embodiment of an air collector workstation assembly 10 in accordance with the present invention. It is contemplated that the air collector workstation 10 is comprised of a workstation housing 12 comprised of a plurality of workstation walls 14 defining a completely or partially enclosed work area 15. It is contemplated that the air collector workstation assembly 10 may be utilized for the control of airborne particulates such as those generated during welding.

The workstation housing 12 operates in combination with an air collector unit 20 to extract and clean the air contained within the work area 15. The workstation housing 12 is comprised of a plurality of frame members 24 comprising support posts 25 and corner posts 27. The plurality of frame members 24 support the mounting of wall panels 26 to completely or partially enclose the work area 15. It is contemplated that the wall panels 26 may be mounted to the frame members 24 in a variety of fashions, including but not limited to screws, nails, bolts, or other attachment methodologies. It is further contemplated that a single wall panel 26 may be installed between adjoining frame members 24 (FIG. 1) or that a plurality of wall panels 26 may be installed between adjoining frame members 24 (FIG. 2). In addition, although the wall panels 26 may very in height, the wall panels 26 preferably are comprised of a standard wall panel width 29. It should be understood, however, that specialized panels for dedicated areas such as entryways may have differing widths. The term wall panel 26 is intended to reflect the sidewalls wherein an air collector unit 20 may be mounted.

The workstation housing 12 further includes a customized hood or ceiling assembly 28. The customized hood 28 is comprised of a hood frame 30 configured to engage the frame members 24 as well as a hood panel 32 configured to at least partially enclose the ceiling region of the work area 15. In at least one embodiment it is contemplated that the hood panel 32 and/or the wall panels may be comprised of clear material in order to allow light to pass through into the work area 15.

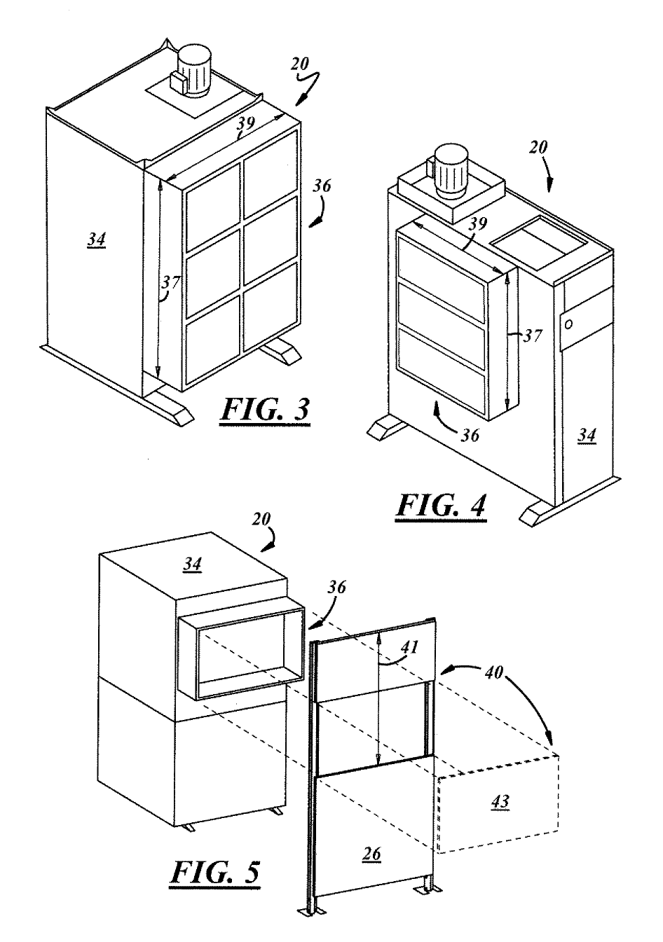

The present invention contemplates a unique arrangement for mounting the air collector unit 20 to a variety of positions along any of the workstation walls 14. The present invention utilizes an air collector unit 20 comprised of a main air collector housing 34 with a mounting profile 36 protruding there from. The mounting profile 36 may also be referred to as a snout 36. It is contemplated that the snout 36 may be formed in a variety of sizes and shapes including but not limited to those illustrated in FIGS. 3 and 4. The snout 36 is comprised of an air intake height 37 and an air intake width 39. The snout 36 may be sized to encompass only a small portion of the workstation wall 14 to which it is mounted (FIG. 4) or a larger portion (FIG. 3). It is preferable, however, for the air intake width 39 to approximately equal the wall panel width 29.

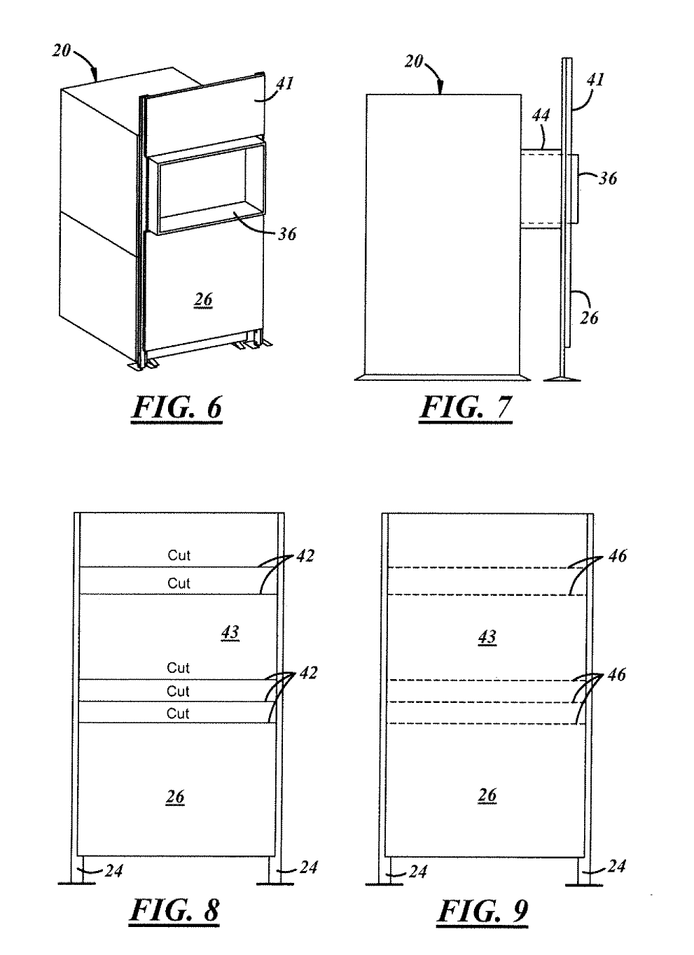

The widely varied configurations and space availability of existing operating facilities makes a static single position mounting of the air collector unit 20 to a single position on the workstation wall 14 undesirable. The present invention provides flexibility in such mounting by way of providing removable wall panels 26 or adjustable dimension wall panels 40. The adjustable dimension wall panels 40 are preferably configured such that their panel height 41 can be modified for different snout air intake heights 37 (see FIGS. 5 and 6). It is contemplated that this adjustable dimension wall panels 40 may be in a variety of configurations. In one embodiment, the material of the wall panels 26 may be configured such that the adjustable dimension wall panel 40 includes a removable panel portion 43 that can be cut out of the desired wall panel 26 and the snout 36 inserted. This allows the air collector units 20 with a wide variety of mounting profiles 36 to be mounting in any location around the workstation walls 14. It is contemplated that the snout 36 may taper outwards slightly as it nears the main air collector housing 34 in order to generate a press fit seal. Alternatively, the present invention contemplates the use of a boot element 44 positioned between the snout 36 and the appropriate wall panel 26 in order to effectuate a proper seal (FIG. 7).

Although the removable panel portion 43 may be configured in a variety of fashions, in one embodiment it is contemplated that the workstation walls 14 and more specifically the adjustable dimension wall panel 40 may have pre-printed templates 42 printed on their exterior that represent a variety of different mounting profiles 36 (FIG. 8). In this fashion, the assembler can quickly and easily identify both the desired position and desired mounting profile corresponding to a particular model of air collector unit 20 prior to removing the removable panel portion 43.

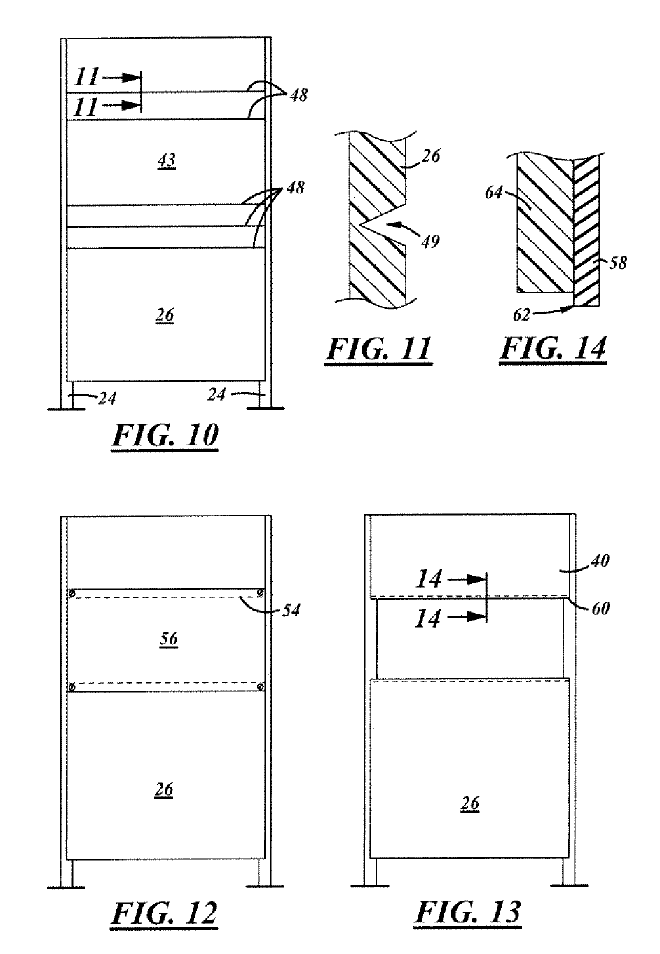

Although the removable panel portion 43 may be easily cut out due to the material configuration of the wall panels 26, a variety of alternative embodiments are also contemplated. It is contemplated that the adjustable dimension wall panel 40 may be comprised of a perforated line 46 which allow simple removal of the removable panel portion 43 (FIG. 9). It is contemplated that the perforations are small enough to not interfere with air flow within the work area 15, but significant enough to allow easy removal. Alternately, it is contemplated that a weakened break line 48 of the adjustable dimension wall panel 40 may be weakened through a variety of methodologies such as thinning of material along the weakened break line 48 with a thinning groove 49 (FIGS. 10 & 11). This allows easy removal with or without cutting tools. Finally, the wall panels 26 may be formed with a pre-existing mounting slot 54 covered by a removable cover 56 (FIG. 12). The removable cover 56 may be mounted and removed in a variety of fashion such as screws or bolts.

In at least one embodiment it is contemplated that the adjustable dimension wall panel 40 include a rubberized external surface 58 (FIGS. 13 & 14). When the removable panel portion 43 is removed, the rubberized external surface 58 acts as a seal against the snout 36. The rubberized external surface 58 preferably has an external surface cut or break line 60 such that when the removable panel portion 43 is removed, a lip portion 62 protrudes past the main panel body 64. This provides an instant seal for the snout 36.

The present invention provides a highly modifiable and versatile air cleaner workstation assembly 10. The ability to mount the air cleaner unit 20 in a variety of positions while still providing a secure mounting connection is highly desirable.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An air collector workstation assembly comprising:
a plurality of workstation walls 14 defining a work area 15, each of said plurality of workstation walls 14 comprising:
a plurality of frame members 24;
a plurality of wall panels 26 removably mounted to said frame members 24, each of said plurality of wall panels 26 comprising a panel width 29 and a panel height 41, at least one of said plurality of wall panels 26 comprising:
an adjustable dimension wall panel 40 including at least one removable panel portion 43 such that said panel height 41 may be adjusted; and
an air collector unit 20 with a mounting profile 36 having an air intake width 39 and an air intake height 37, said air intake width 39 approximately equal to said panel width 29;
wherein said at least one removable panel portion 43 can be removed and said mounting profile 36 inserted such that said air collector 20 is in communication with said work area 15.

2. An air collector workstation assembly as described in claim 1, further comprising:
a boot element 44 configured to mount between said mounting profile 36 and said adjustable dimension wall panel 40 such that said mounting profile 36 is sealingly engaged to said one of said workstation walls 14.

3. An air collector workstation assembly as described in claim 1, wherein said adjustable dimension wall panel 40 comprises:
a perforated line 46 fanned therein wherein said removable panel portion 43 may be removed from said adjustable dimension wall panel 40 by separating along said perforated line 46.

4. An air collector workstation assembly as described in claim 1, wherein said adjustable dimension wall panel 40 comprises:
a weakened break line 48 formed therein by way of thinning groove 49, wherein said removable panel portion 43 may be removed from said adjustable dimension wall panel 40 by separating along said weakened break line 48.

5. An air collector workstation assembly as described in claim 1, wherein said adjustable dimension wall panel 40 comprises:
at least one pre-printed template 42 printed on said adjustable dimension wall panel 40 to indicate said removable panel portion 43.

6. An air collector workstation assembly as described in claim 1, wherein said adjustable dimension wall panel 40 comprises:
a rubberized external surface 58 with an external surface break line 60 such that when said removable panel portion 43 is removed, said rubberized external surface 58 includes a lip portion 62 that protrudes past a main panel body 64.

7. An air collector workstation assembly as described in claim 1, wherein said removable panel portion 43 comprises:
a removable cover 56 removable secured to said adjustable dimension wall panel 40.

8. An air collector workstation assembly as described in claim 1, wherein said mounting profile 36 is tapered to seal against one of said workstation walls 14 when installed.

9. An air collector workstation assembly comprising:
a plurality of workstation walls 14 defining a work area 15, each of said plurality of workstation walls 14 comprising:
a plurality of frame members 24;
a plurality of wall panels 26 removably mounted to said frame members 24, each of said plurality of wall panels 26 comprising a panel width 29 and a panel height 41; and
an air collector unit 20 with a mounting profile 36 having an air intake width 39 and an air intake height 37, said air intake width 39 approximately equal to said panel width 29, said air intake height 47 a multiple of said panel height 41;
wherein said mounting profile 36 can be accommodated in any location along said workstation walls 14 by way of removing one or more of said wall panels 26.

10. An air collector workstation assembly as described in claim 3, wherein at least one of said plurality of wall panels 26 comprises:
an adjustable dimension wall panel 40 including at least one removable panel portion 43 such that said panel height 41 may be adjusted;
wherein at least one removable panel portion 43 can be removed and said mounting profile 36 inserted such that said air collector 20 is in communication with said work area 15.

11. A method of assembling an air collector workstation comprising:
an air collector workstation assembly comprising:
assembling a plurality of workstation walls 14 to define a work area 15 by way of mounting a plurality of wall panels 26 to a plurality of frame members 24, each of said plurality of wall panels comprising a panel width 29 and a panel height 41, at least one of said plurality of wall panels 26 comprising an adjustable dimension wall panel 40 including at least one removable panel portion 43;
adjusting the panel height 41 of said adjustable dimension wall panel 40 by removing a removable panel portion 43 to accommodate an air collection unit 20 with a mounting profile 36 having an air intake width 39 and an air intake height 37, said air intake width 39 approximately equal to said panel width 29;
replacing said removable panel portion 43 by inserting said mounting profile 36 such that said air collector 20 is in communication with said work area 15.

12. A method as described in claim 11, further comprising:
installing a boot element 44 between said mounting profile 36 and said adjustable dimension wall panel 40 such that said mounting profile 36 is sealingly engaged to said one of said workstation walls 14.

13. A method as described in claim 11, wherein said removing said removable panel portion 43 comprises:
separating said removable panel portion 43 along a perforated line 46 formed in said adjustable dimension wall panel 40.

14. A method as described in claim 11, wherein said removing said removable panel portion 43 comprises:
separating said removable panel portion 43 along a weakened break line 48 formed in said adjustable dimension wall panel 40 by way of thinning groove 49.
